(19) United States
(12) Patent Application Publication
(10) Pub. No.: US 2019/0026696 A1
(43) Pub. Date: Jan. 24, 2019

(54) SYSTEM AND METHOD TO ENABLE SHARING OF DELIVERY RESOURCES BETWEEN NON-AFFILIATED ENTITIES

(71) Applicant: Walmart Apollo, LLC, Bentonville, AR (US)

(72) Inventors: Todd D. Mattingly, Bentonville, AR (US); Greg N. Vukin, Bentonville, AR (US); Bruce W. Wilkinson, Rogers, AR (US); Michael R. Bright, Bentonville, AR (US)

(21) Appl. No.: 16/041,024

(22) Filed: Jul. 20, 2018

Related U.S. Application Data
(60) Provisional application No. 62/535,439, filed on Jul. 21, 2017.

(51) Int. Cl. G06Q 10/08

(52) U.S. Cl. CPC G06Q 10/08355; G05D 1/021

(57) ABSTRACT

In some embodiments, systems and methods are provided herein useful to enable sharing of commercial delivery vehicles across multiple commercial entities to facilitate the delivery of commercial products. In some embodiments, the system includes an electronic user device having a delivery interface, mobile analytics information (“MAI”) for a plurality of mobile devices, and commercial distribution analytics information (“CDAI”) that prescribes transportation information as well as delivery information and a control circuit(s). The control circuit(s) uses the CDAI to identify a delivery route(s) of interest. The control circuit(s) uses the delivery route of interest, the MAI, and the CDAI to identify a distribution solution that dictates use commercial delivery vehicle to deliver a commercial product(s) with the delivery information of the commercial product. The control circuit(s) causes the transceiver to transmit the distribution solution to the delivery interface for processing and thereby cause initiation of the distribution solution.

### CROSS-REFERENCE TO RELATED APPLICATION

This application claims the benefit of the following U.S. Provisional Application No. 62/535,439 filed Jul. 21, 2017, which is incorporated herein by reference in its entirety.

### TECHNICAL FIELD

This invention relates generally to managing the delivery of retail products.

### BACKGROUND

Various branches of mobile analytics are known in the art. As used herein, “mobile analytics” refers to data representing the location and travel over time of mobile communications devices such as cellular telephony devices (including both voice only, data only, and both voice and data compatible devices) and the analysis of such data. Mobile analytics data can be real-time, near-real time (where the data represents circumstances within at least the past, say, ten seconds, thirty seconds, one minute, or the like), and/or historical scenarios.

Mobile analytics data can be captured, for example, by cellular telephony service providers by recording and aggregating as appropriate the service provider's view of their mobile subscribers as those subscribers move and become attached to or otherwise viewed by various cell towers. In many cases a given customer device is visible to a plurality of antenna towers and the location of the customer device can be reliably ascertained by triangulating that location based, for example, on the relative strength of the device's signal at each of the towers. It is also possible that a customer device may have its own native capability of ascertaining its own location, which location the device transmits to the service provider on a push or pull basis as desired to support any of a variety of services (such as, for example, presence-based services).

Mobile analytics data has been analyzed to identify, for example, cellular towers or other network elements that are relatively overloaded and which need to be upgraded or supplemented to continue to assure a quality customer experience. More recently there have been suggestions that mobile analytics data might be useful to retailers and other non-communications service providers to help with their marketing plans. To date, however, such possibilities remain largely without realization.

### BRIEF DESCRIPTION OF THE DRAWINGS

Disclosed herein are embodiments of systems and methods pertaining to sharing commercial delivery vehicles across multiple commercial entities to facilitate the delivery of commercial products. This description includes drawings, wherein:

FIG. 1 comprises a flow diagram as configured in accordance with various embodiments of these teachings;

FIG. 2 comprises a mobile analytics map as configured in accordance with various embodiments of these teachings;

FIG. 3 comprises a flow diagram as configured in accordance with various embodiments of these teachings;

FIG. 4 comprises a block diagram as configured in accordance with various embodiments of these teachings;

FIG. 5 comprises a block diagram as configured in accordance with various embodiments of these teachings.

FIG. 6 comprises a flow diagram as configured in accordance with various embodiments of these teachings.

FIG. 7 comprises a block diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems and methods are provided herein useful to enable sharing of commercial delivery vehicles across multiple commercial entities to facilitate the delivery of commercial products. In some embodiments, systems are provided to enable sharing of commercial delivery vehicles across multiple commercial entities to facilitate the delivery of commercial products, and may comprise: one or more control circuits communicatively coupled to a transceiver, one or more electronic user devices (e.g., each comprising a delivery interface stored thereon), one or more first databases of information, and one or more second database of information. By one approach, the first databases of information can include information corresponding to mobile analytics information (“MAI”) for a plurality of mobile devices as well as information regarding the locations of the plurality of mobile devices.

By one approach, the second database of information can be communicatively coupled to a plurality of commercial entities (e.g., nonaffiliated commercial entities) each configured to transmit commercial distribution analytics information (“CDAI”) to the second database for storage. For example, the CDAI can include at least one of: transportation information regarding a plurality of commercial delivery vehicles (“CDV”) each associated with a particular first commercial entity of the plurality of commercial entities, and delivery information regarding a plurality of commercial products each requiring delivery to a particular delivery destination and each associated with a particular second commercial entity of the plurality of commercial entities.

The one or more control circuits can be configured to use the CDAI to identify one or more delivery routes of interest. The one or more control circuits can be configured to use the delivery route of interest, the MAI, and the CDAI to identify a distribution solution(s) that dictates use of one or more CDVs of the plurality of CDVs to deliver one or more commercial products of the plurality of commercial products in accordance with the delivery information associated with the one or more commercial products. The one or more control circuits can be configured to cause the transceiver to transmit the distribution solution(s) to the electronic user device(s) for processing by the delivery interface(s) and thereby cause initiation of the distribution solution(s).

In some embodiments, methods are provided to enable the sharing of delivery vehicles across multiple commercial entities to facilitate the delivery of commercial products. Some of these methods access one or more first databases of information corresponding to mobile analytics information (“MAI”) for a plurality of mobile devices. By one approach, the MAI can include information regarding the locations of the plurality of mobile devices. accessing, via the control circuit, One or more second databases communicatively coupled to a plurality of commercial entities can be accessed, where each commercial entity can be configured to transmit commercial distribution analytics information (“CDAI”) to the one or more second databases for storage. By one approach, the CDAI can include at least one of: transportation information regarding a plurality of commercial delivery vehicles (“CDV”) each associated with a particular first commercial entity of the plurality of commercial entities, and delivery information regarding a plurality of commercial products each to be delivered to a particular delivery destination and each associated with a particular second commercial entity of the plurality of commercial entities.

The CDAI can be used to identify at least one delivery route of interest. The delivery route of interest, the MAI, and the CDAI can be used to identify a distribution solution that dictates use of one or more CDVs of the plurality of CDVs to deliver a commercial product(s) of the plurality of commercial products in accordance with the delivery information associated with the commercial product(s). The identified distribution solution(s) can be transmitted to an electronic user device via a transceiver(s) for processing by a delivery interface(s) stored on the electronic device(s) and thereby cause initiation of the distribution solution(s).

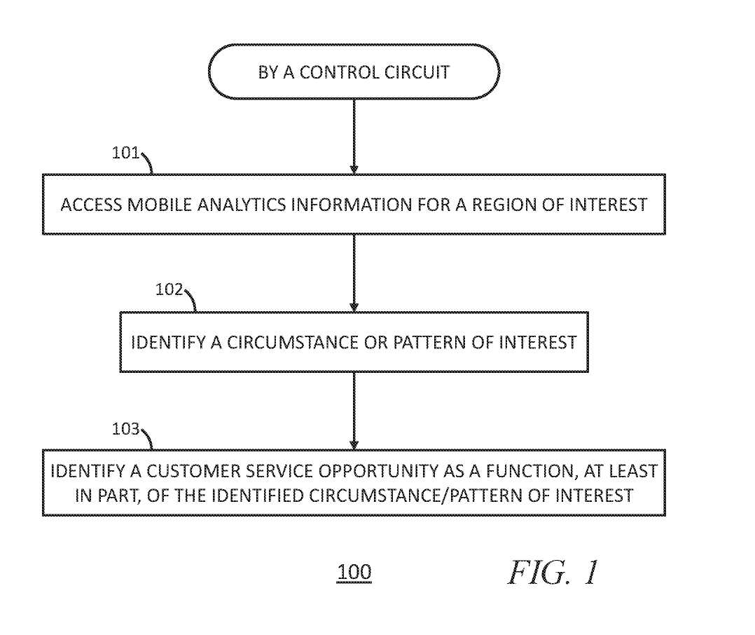

These and other benefits may become clearer upon making a thorough review and study of the following detailed description. Referring now to the drawings, and in particular to FIG. 1, an illustrative process 100 that is compatible with many of these teachings will now be presented. In this description it will be presumed that a control circuit of choice carries out one, some, or all of the described activities that comprise this process 100. Specific examples of such a control circuit are provided further below.

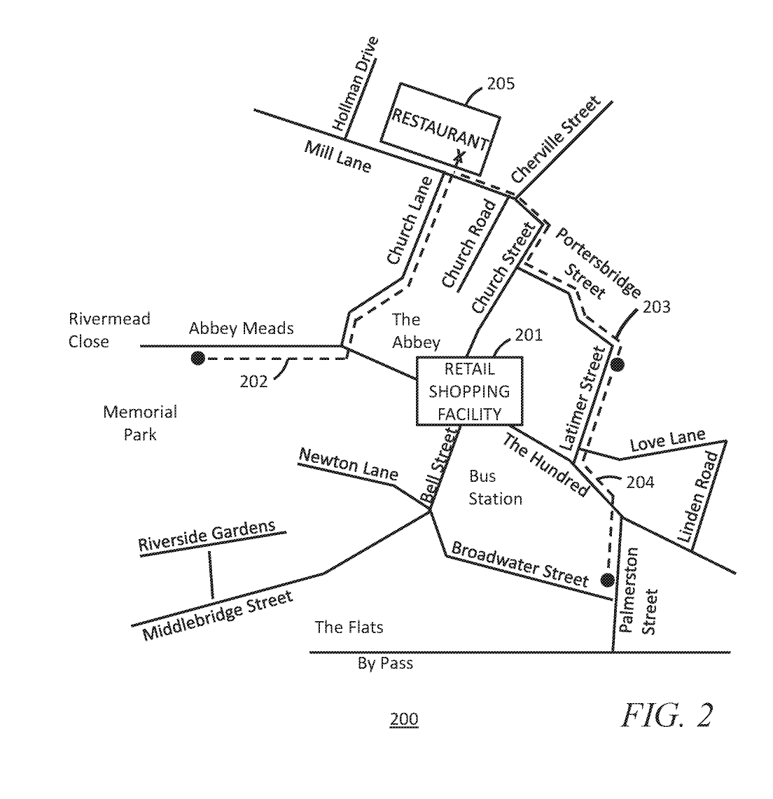

At block 101 this process 100 provides for accessing mobile analytics information for a region of interest. FIG. 2 provides a simple illustrative example in these regards. In particular, FIG. 2 presents an illustration of a street map for a region of interest 200. In this example a retail shopping facility 201 appears at the center of the region of interest 200.

As used herein, the expression “retail shopping facility” will be understood to refer to a facility that comprises a retail sales facility or any other type of bricks-and-mortar (i.e., physical) facility in which products are physically displayed and offered for sale to customers who physically visit the facility. The shopping facility may include one or more of sales floor areas, checkout locations (i.e., point of sale (POS) locations), customer service areas other than checkout locations (such as service areas to handle returns), parking locations, entrance and exit areas, stock room areas, stock receiving areas, hallway areas, common areas shared by merchants, and so on. The facility may be any size or format of facility, and may include products from one or more merchants. For example, a facility may be a single store operated by one merchant or may be a collection of stores covering multiple merchants such as a mall.

In this simple example the mobile analytics information illustrates tracking information for three separate mobile devices (such as so-called smart phones). These three separate tracks are denoted by reference numerals 202-204. A dark circle denotes a point of origin and an “X” character denotes a terminus point, both as corresponding to a particular journey for a particular mobile device. (It shall be understood that these conventions are used here for the sake of illustration and that any number of graphic approaches can be readily utilized to convey identical or similar information as desired.)

Mobile analytics information can include, inferentially or explicitly, temporal information as well. In the illustration of FIG. 2, for example, the information displayed may represent a particular window of time such as 10 minutes, one hour, or one day (to note but a few possibilities in these regards). If desired, time information can be associated with one or more parts of an individually-displayed track (such as a start time associated with a point of origin or an arrival time associated with a terminus point).

The presentation of such information can be provided to a user on a real-time basis if desired or can be historical in nature if desired (for example, by displaying information from a previous day and without showing information that is more up to the minute). It will also be understood that color or other graphic affectations can be utilized as desired to impart information. For example, different colors can be utilized to disambiguate amongst a plurality of displayed devices. As another example, one color can serve to identify movement during one time of the day (such as during the morning hours) while another color identifies movement during a different time of the day (such as during the afternoon hours). And as yet another example, one color could indicate movement away from a region of interest while another, different color could indicate movement towards a region of interest.

The information presented in FIG. 2 includes only three devices/tracks. Only this limited number of devices are presented here for the sake of simplicity and clarity. In a typical application setting, dozens, hundreds, or even thousands of devices/tracks may be simultaneously presented on such a display/map. Accordingly, some mobile analytics platforms may provide the user with an opportunity to select and sort amongst a plurality of displayed devices/tracks to better facilitate the user's understanding and analysis of the displayed information.

With continued reference to both FIGS. 1 and 2, at block 102 this process 100 provides for identifying within the mobile analytics information a circumstance or pattern of interest. In the simple example of FIG. 2, the circumstance/pattern constitutes identifying restaurants being visited by persons that appear to live or work within the region of interest 200. In this example the three devices/tracks 202-204 all have a point of origin within the region of interest 200 and all include a stop at the same restaurant 205. (Other likely available information regarding other travels by these devices, including where these devices went after visiting the restaurant 205, are not shown here for the sake of clarity.)

At block 103 this process 100 provides for identifying a customer service opportunity as a function, at least in part, of the identified circumstance/pattern of interest. In the present example the circumstance/pattern of interest suggests that persons living within the region of interest 200 (and hence within convenient access to the retail shopping facility 201) enjoy eating meals at this particular restaurant 205. Upon further investigating this particular restaurant 205, it may be determined, for example, that this restaurant 205 offers a particular kind of ethnic food. In that case, this process 100 may provide for stocking the retail shopping facility 201 with food items (including meats, produce, spices, and so forth) that typify (perhaps uniquely) the aforementioned ethnic food but which might not otherwise be ordinarily carried by this retail shopping facility.

These teachings will accommodate a wide variety of circumstances and/or patterns of interest. Examples in these regards include but are not limited to traffic patterns (for example, times when particular streets or intersections are especially heavy with traffic or relatively clear of traffic), apparent gatherings of people at non-retail venues, travel patterns for apparent commuters in the region of interest (including, for example, commuting patterns driven in part by the availability or unavailability of work-time flexibility such that employees leave their homes for work over wider or narrower time windows), residential patterns (for example, patterns regarding where people live relative to their employer), traffic patterns regarding people who are likely sharing a same road at the same time, travel patterns of students traveling between school and home, and so forth.

Similarly, these teachings will also accommodate a wide variety of resultant customer service opportunities. Examples in these regards include but are not limited to items to be offered as complementary samples at a retail shopping facility or at another location suggested by the mobile analytics information, items to be offered at food trucks or other mobile offerings platforms, sponsorship opportunities for the retail shopping facility, traveler-dependent content to be displayed via roadside electronic billboards, and so forth.

In the examples above the mobile analytics information presumably provides no information that the retail shopping facility can utilize to directly identify a user or other entity that corresponds to any of the tracked mobile devices. Notwithstanding the anonymous nature of the mobile analytics information, as shown above that information can nevertheless provide many helpful insights and clues to improve product and service offerings by such a retail shopping facility.

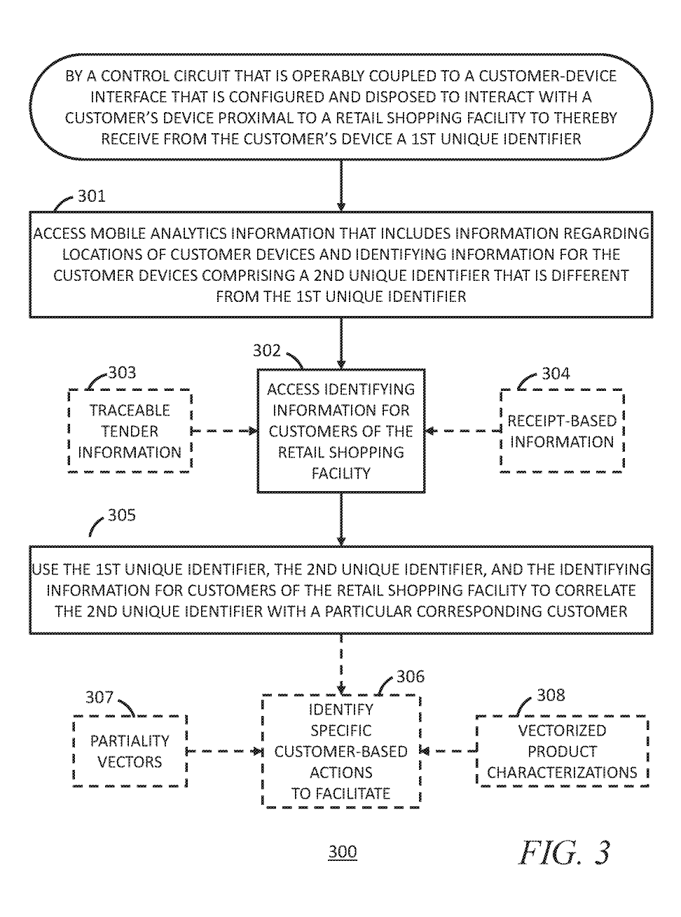

Referring now to FIG. 3, these teachings also contemplate an approach that permits anonymous mobile analytics information to be employed, at least in part, to identify a particular device user and to use that identification to greatly personalize the customer service opportunity that may be provided to such a customer. In a typical application setting this personalization is undertaken subject to the permission and possible other stipulations and requirements of the customer.

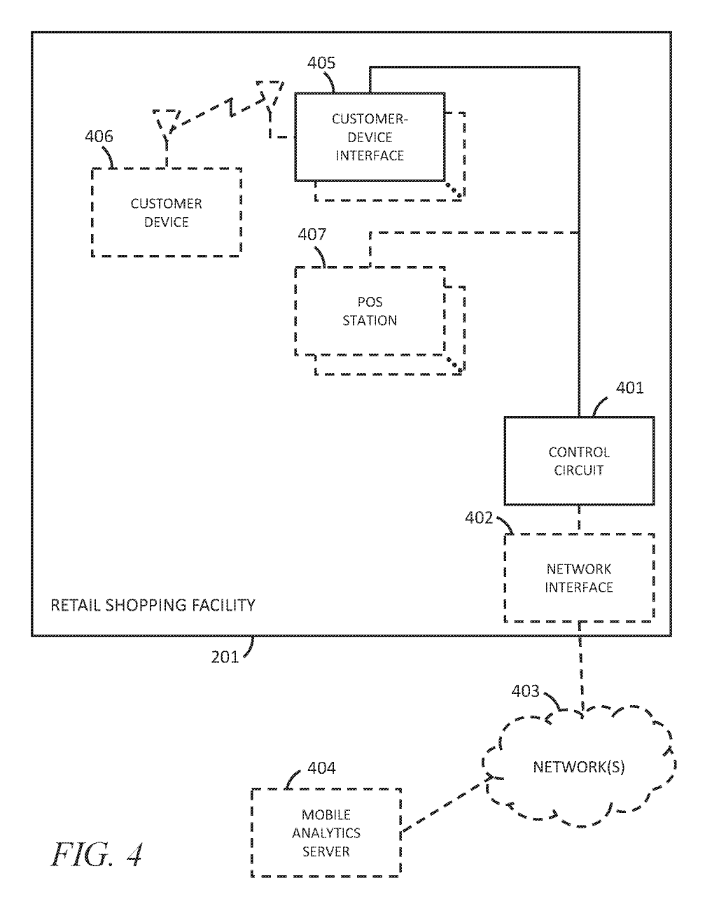

In particular, FIG. 3 presents a process 300 that can be carried out by a control circuit that operably couples to a customer-device interface that interacts with a customer's device proximal to a retail shopping facility to thereby receive a unique identifier from the customer's device. FIG. 4 provides an illustrative example in this regard.

In this example a retail shopping facility 201 includes a control circuit 401. Being a “circuit,” this control circuit 401 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 401 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 401 is configured (for example, by using corresponding programming as will be well understood by those skilled in the art) to carry out one or more of the steps, actions, and/or functions described herein.

By one optional approach the control circuit 401 operably couples to a memory (not shown). This memory may be integral to the control circuit 401 or can be physically discrete (in whole or in part) from the control circuit 401 as desired. This memory can also be local with respect to the control circuit 401 (where, for example, both share a common circuit board, chassis, power supply, and/or housing) or can be partially or wholly remote with respect to the control circuit 401 (where, for example, the memory is physically located in another facility, metropolitan area, or even country as compared to the control circuit 401).

This memory can serve, for example, to non-transitorily store computer instructions that, when executed by the control circuit 401, can cause the control circuit 401 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

By one approach the control circuit 401 optionally operably couples to a network interface 402. So configured the control circuit 401 can communicate with other network elements (such as but not limited to a mobile analytics server 404 that provides mobile analytics information per these teachings) using one or more intervening networks via the network interface 402. Network interfaces, including both wireless and non-wireless platforms, are well understood in the art and require no particular elaboration here. These teachings will support using any of a wide variety of networks including but not limited to the Internet (i.e., the global network of interconnected computer networks that use the Internet protocol suite (TCP/IP)).

In this illustrative example the control circuit 401 operably couples to at least one customer-device interface 405. The customer-device interface can comprise, by one approach, a wireless interface such as but not limited to a Wi-Fi access point and/or a Bluetooth transceiver. (As used herein “Wi-Fi” will be understood to refer to a technology that allows electronic devices to connect to a wireless Local Area Network (LAN) (generally using the 2.4 gigahertz and 5 gigahertz radio bands). More particularly, “Wi-Fi” refers to any Wireless Local Area Network (WLAN) product based on interoperability consistent with the Institute of Electrical and Electronics Engineers' (IEEE) 802.11 standards. Also as used herein, “Bluetooth” will be understood to refer to a wireless communications standard managed by the Bluetooth Special Interest Group. The Bluetooth standard makes use of frequency-hopping spread spectrum techniques and typically provides for only a very short range wireless connection (typically offering a range of only about ten meters in many common application settings). This standard comprises a packet-based approach that relies upon a so-called master-slave paradigm where a master device can support only a limited (plural) number of subservient devices.)

The customer-device interface 405 is configured and disposed to interact with a customer's device 406 proximal to the retail shopping facility 201. In a typical application setting this interaction will constitute a wireless communication of information. As used herein, the customer's device 406 is “proximal” to the retail shopping facility 201 when the customer's device 406 is within the retail shopping facility 201 and/or when the customer's device 406 is within a short distance of the retail shopping facility 201 (such as, for example, 1 meter, 5 meters, 10 meters, 30 meters, or some other minimal distance of choice).

As already noted above, the customer-device interface serves, at least in part, to receive from the customer's device 406 a first unique identifier. Generally speaking this first unique identifier does not directly identify the user of the customer's device 406. For example, the first unique identifier is not the full or abridged name of the customer nor a full or abridged name of a personally-selected customer avatar.

Instead, and by one approach, the first unique identifier comprises a Media Access Control (MAC) address for the customer's device 406. A MAC address of a computer is a unique identifier assigned to network interfaces for communications at the data link layer of a network segment. MAC addresses are used as a network address for many IEEE 802 network technologies, including Ethernet, Wi-Fi, and often Bluetooth. Logically, MAC addresses are used in the media access control protocol sublayer of the OSI reference model. MAC addresses are most often assigned by the manufacturer of a Network Interface Controller (NIC) and are stored in its hardware, such as the card's read-only memory or some other firmware mechanism. If assigned by the manufacturer, a MAC address usually encodes the manufacturer's registered identification number and may be referred to as the burned-in address. It may also be known as an Ethernet hardware address, hardware address, or physical address. MAC addresses are formed according to the rules of one of three numbering name spaces managed by the Institute of Electrical and Electronics Engineers, (i.e., MAC-48, EUI-48, and EUI-64).

As one illustrative example, the customer device 406 may comprise a so-called smart phone having Wi-Fi and/or Bluetooth conductivity capabilities. When the customer device 406 is within a range of the customer-device interface 405, these two elements may automatically communicate with one another during which communication the customer device 406 provides its MAC address to the customer-device interface 405. The customer-device interface 405 then supplies that MAC address to the control circuit 401.

As illustrated in FIG. 4, the retail shopping facility 201 may also optionally include one or more so-called point of sale (POS) stations 407. A POS station 407 is where a customer completes a retail transaction. Typically, the retailer calculates the amount owed by the customer and indicates that amount to the customer. The POS station 407 also serves as the point where the customer pays the retailer in exchange for goods or after provision of a service. After receiving payment, the retailer may issue a receipt (hard copy or otherwise) for the transaction. The POS station 407 may be directly attended by an associate of the retail shopping facility 201 or may be partially or wholly automated.

In many cases the customer's payment includes traceable tender information such as the customer's name or an identifier that can be readily and directly linked to the customer's name. In this example the control circuit 401 is configured to access at least some traceable tender information from a POS station 407 corresponding to purchases made by customers at the retail shopping facility 201.

With continued reference to FIGS. 3 and 4, this process 300 provides, at block 301, for having the control circuit 401 access mobile analytics information (sourced, for example, by the aforementioned mobile analytics server 404). This mobile analytics information includes information regarding locations of customer devices and identifying information for the customer devices comprising a second unique identifier that is different from the aforementioned first unique identifier.

The received information regarding locations of customer devices can vary as described above. By one approach the information provides mapped tracking information for a plurality of customer devices within some report region over some relevant period of time. Different colors can be used to parse the informational content and graphic icons can be utilized to indicate times, events, and other parameters of interest as desired.

Generally speaking, those who provide mobile analytics information do not provide that information in conjunction with any content that specifically identifies a particular user. For example, the provided content typically lacks user names or other user monikers, telephone numbers, email addresses, or the like. On the other hand, mobile analytics information often includes an identifier for each track and/or displayed device in order to help the analyst disambiguate the depicted information. The second unique identifier may therefore comprise, for example, a mobile device Electronic Serial Number (ESN), a mobile device International Mobile Equipment Identity (IMEI) number, or a (possibly random) number/identifier assigned by a wireless-communications service provider and/or the party providing the mobile analytics information.

It may be noted that the second unique identifier may be displayed on a map that presents the mobile analytics tracking data. By another approach the second unique identifier may be revealed by effecting some selection action with respect to a particular track (for example, double-clicking on a particular track). The present teachings are relatively insensitive to how the second unique identifiers are included with the received mobile analytics information.

At block 302 the control circuit 401 accesses identifying information for customers of the retail shopping facility 201. By one optional approach this identifying information may be obtained from traceable content information 303 that corresponds to purchases made by the customers at the retail shopping facility 201 as captured by, for example, the aforementioned POS station 407. For example, a customer's name is typically included with other information presented at the POS station 407 when paying for a purchase using a credit card or a debit card.

By another optional approach, in lieu of the foregoing or in combination therewith, the identifying information may be received along with other receipt-based information 304 that is provided directly by customers. Such receipt-based information 304 can also serve to correlate purchases made by customers at the retail shopping facility 201 with their corresponding identifying customer information. A customer can be enabled to directly provide such information using, for example, a smart phone app provided or otherwise supported by the enterprise that operates the retail sales facility 201. Such an app can provide an opportunity for the customer to maintain a virtual record of their shopping or can, for example, serve as a way for the customer to have the enterprise check and ensure that prices paid by the customer meet some pricing guarantee of the enterprise.

At block 305, the control circuit 401 uses the first unique identifier, the second unique identifier, and the identifying information for customers of the retail shopping facility 201 to statistically (or, perhaps more accurately, by the process of elimination) correlate one of the second unique identifiers with a particular corresponding customer.

More specifically, for a given block of time the control circuit 401 knows which customer devices are likely at the retail shopping facility 201 by referencing the mobile analytics information. In particular, the control circuit 401 knows particular second unique identifiers that have arrived at the retail shopping facility 201. For that same block of time the control circuit 401 also knows which customer devices have presented the aforementioned first unique identifier at the retail shopping facility 201. And lastly, and again for that same block of time, the control circuit 401 further knows the names of (at least many) specific customers who made purchases at the retail shopping facility 201.

The control circuit 401 uses the foregoing information to accurately correlate a particular customer to a particular anonymized mobile device identifier as used with the mobile analytics information, in many cases, as a result of only a single customer visit to the retail shopping facility 201. In other cases there may be sufficient customer/device activity to create some ambiguity in these regards after only a single customer visit. In that case, the ambiguity can be relieved and an accurate correlation made after X number of additional visits by a particular customer to the retail shopping facility 201 (where X is an integer of 1 or greater).

So configured, and particularly over time, the control circuit 401 can personalize the previously anonymized mobile analytics information to thereby associate particular customers with particular identifiers for various mobile devices/tracks. Accordingly, the control circuit 401 can utilize that personalization when analyzing later-received mobile analytics information in various ways to benefit the identified customers.

Optional block 306 provides some illustrative examples in these regards. Here, the control circuit 401 uses the now-personalized mobile analytics information to identify specific customer-based actions to facilitate. In particular, and as one example in these regards, the control circuit 401 can employ partiality vectors 307 that correspond to the identified customer and vectorized product characterizations 308 in combination with information regarding where the now-identified customer travels, visits, shops, and otherwise engages themselves to identify particular products and/or services to make available to the customer.

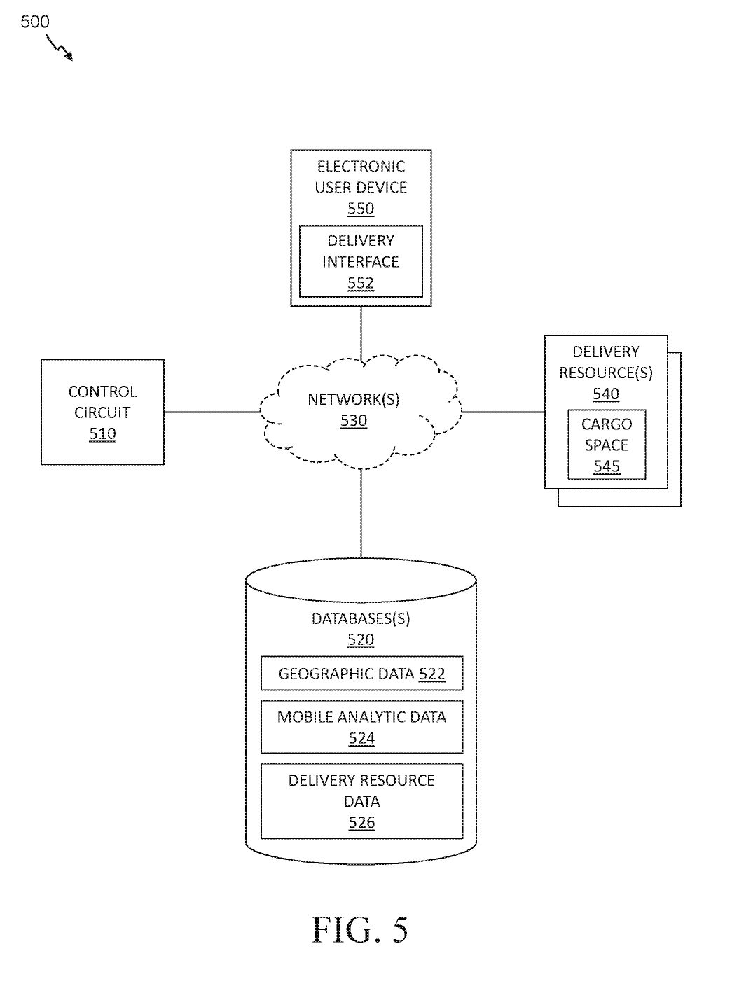

In reference to FIGS. 5-7, embodiments discussed herein correspond to sharing of commercial delivery vehicles across multiple non-affiliated commercial entities to facilitate the delivery of commercial products and may utilize one or more concepts, steps, processes, functions, elements, and/or components discussed above in reference to one or more of FIGS. 1-4. These teachings also contemplate an approach that permits mobile analytics information to be leveraged with geographic information and delivery scheduling information to enable sharing of commercial delivery vehicles across multiple non-affiliated commercial entities to facilitate the delivery of commercial products. “Logistics” can refer to the process of transporting commercial products from the point of manufacture/storage to the point of consumption by the final consumer. Logistics can be viewed as a customer-focused aspect of business (i.e., the customer is typically the key to all logistics activities).

Logistics can add value to the supply chain in various ways (e.g., by getting the commercial products to the customer faster, in a better condition, at a time that suits the customer, at a place that suits the customer, etc.) and may benefit from a reduction or elimination of certain inefficiencies. For example, commercial entities typically have a finite amount of delivery vehicles available with which to transport their commercial products to consumers, which may at times sit idle at their premises or may travel with unoccupied cargo space or available cargo space. By one approach, to reduce such inefficiencies, these teaching provide for the sharing of commercial delivery vehicles across multiple non-affiliated commercial entities to facilitate the delivery of commercial products. In particular, FIG. 5 illustrates a simplified block diagram of a system 500 to enable sharing of commercial delivery vehicles across multiple non-affiliated commercial entities to facilitate the delivery of commercial products in accordance with the teachings of some embodiments.

In this example, system 500 can include one or more delivery resources 540, electronic user devices 550, databases 520, and control circuits 510 communicating over a computer and/or one or more communication networks (“networks”) 530. Being a “circuit,” the control circuit 510 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings. Such a control circuit(s) 510 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit(s) 510 can be configured (for example, by using corresponding programming as will be well understood by those skilled in the art) to carry out one or more of the steps, actions, and/or functions described herein.

Networks 530 can be, for example, a local area network (LAN), a wide area network (WAN) such as the Internet, or a combination of the two, and includes wired, wireless, fiber optic connections, other such communication methods, or combination of two or more of such communication methods. In certain embodiments, the networks 530 can include the networks 403 or may be included therein. In general, the network 530 can be any combination of connections and protocols that can support communications between the delivery resources 540, the electronic user devices 550, the databases 520, and the control circuits 510.

The electronic user devices 550 can be one or more desktop computers, laptop computers, a thin clients, smart TVs, in-vehicle computing devices, wearable computing devices, or mobile devices, including but not limited to, smart phones, phablets, tablets, and similar mobile devices. In some embodiments, the electronic user device 550 may be a plurality of communicatively coupled electronic user devices that interact with each other and share computing resources to execute the delivery interface 552. In general, electronic user device 550 can be any computing device that can execute delivery interface 552 and communicate via network 530, in accordance with some embodiments of these teachings. The plurality of the electronic user devices 550 can be associated with a plurality of non-affiliated commercial entities. For example, one or more of the plurality of electronic user devices 550 can be associated with a particular commercial entity of the plurality of non-affiliated commercial entities. By one approach, each particular commercial entity uses one or more delivery resources 540 to deliver its commercial items to customers, distribution centers, warehouses, and/or similar destinations.

In some embodiments, each delivery interface 552 includes software that can be configured to facilitate the management of delivery appointments and/or bookings for one or more particular delivery resources 540. In some embodiments, the delivery interface 552 can capture delivery resource data about the delivery resources 540 (e.g., geolocation data, delivery routing information, storage capacity, recipient information, etc.). In some embodiments, the delivery resource data can include transportation information regarding a plurality of commercial delivery vehicles (“CDV”), such as the delivery resources 540, each associated with a particular commercial entity, and delivery information regarding a plurality of commercial products each to be delivered to a particular delivery destination and each associated with a particular commercial entity. In some embodiments, the delivery interface(s) 552 may capture and/or receive geolocation data (such as latitude and longitude, GPS coordinates, Global Navigation Satellite Systems (GNSS) data, mapping information, address information, and/or other such location information) that reflects the present location of one or more of the delivery resources 540. In some embodiments, data captured by one or more of the delivery interfaces 552 can be transmitted, via electronic user device 550, to one or more of the control circuits 510, delivery resource data 1126, a central database(s), and an external database(s) communicatively coupled to the networks 530.

As illustrated, the delivery interface 552, which may be operated at one or more electronic user devices 550, may be communicatively coupled over one or more distributed communication networks such as network 530. Delivery interface 552, for example, can include one or more graphical icons, visual indicators, and/or command-line indicators that allow delivery users to interact with the delivery user interface 142. Delivery users or agents can be commercial entities that own, rent, lease, and/or operate one or more delivery resources 540 and opt-in (e.g., the delivery resources 540 can be downloaded to or accessed via the electronic user device 550 and participation therewith agreed to) to share delivery resources with non-affiliated commercial entities to facilitate delivery of commercial products, in accordance with some embodiments of these teachings. Delivery agents can interact with the delivery interfaces 552 via manipulation of the electronic user device 550, such as, for example, by manipulating graphical icons and/or visual indicators displayed on the electronic user device. Additionally, or alternatively, delivery users can interact with the delivery interfaces 552 by issuing one or more commands into the command-line interfaces.

Delivery users can use the delivery interfaces 552 to submit registration data associated with the delivery resources 540 to the control circuits 510. For example, the registration data can include vehicle-related information (e.g., make, model, year, service history, vehicle identification number, vehicle availability, storage capacity, towing capacity, storage climate data, fuel economy, vehicular technical specifications, storage space rental rates, and similar vehicle-related information), driver-related information (e.g., age, license number, driving record, driver availability, driver service rates, and similar driver-related information), account information, associated commercial entity, and/or payment information, among other data. By one approach, the delivery resources 540 can be mobile machines that can be configured to transport commercial products.

The delivery resources 540, for example, can each be configured to traverse environments via the use of one or more of a terrestrial propulsion system, aerial propulsion system, aquatic propulsion system, similar propulsion systems, or a combination of two or more of the aforementioned propulsion systems.

In one embodiment, the delivery resources 540 may be driven by the delivery agents in the vehicles. In another embodiment, the delivery resources 540 can navigate an environment autonomously, semi-autonomously, via human intervention, or a combination of two or more of the aforementioned navigational methods. Delivery resources 540, in certain embodiments, can have one or more cargo spaces 545, which are three-dimensional volumes configured to store and/or transport one or more commercial products. The cargo spaces 545 may be trunk spaces, cabin spaces, glove compartments, storage areas, or similar spaces within delivery resources 540 capable of storing at least one commercial product for transportation to delivery destinations. In certain embodiments, cargo spaces 545 can include climate control capabilities (e.g., temperature, humidity, and/or pressure control). In certain aspects, one or more of the cargo spaces 545 can each include one or more vehicle cargo space sensors positioned proximate to one or more surfaces thereof and configured to assess or detect the available cargo space (i.e., the cargo space which is not occupied and/or cargo space that is occupied) within a delivery resource 540 and transmit such information to the delivery interface 552. For example, the sensors may include one or more distance measurement sensors (e.g., light, sound, etc.), one or more cameras and image processing systems, RFID tag readers, weight sensors, other such sensors, or a combination of two or more of such sensors. With this information, for example, the currently available cargo space and, the cargo space typically available in the delivery resources 540 and/or the manufacturer supplied cargo space or cargo capacity, if the necessary information was provided when the delivery resources 540 was registered with the system, can be ascertained. Additionally or alternatively, one or more control circuits 510 can access one or more inventory listings associated with a particular delivery resource 540. The inventory listing typically specifics the cargo being transported by the delivery resource. The one or more control circuits can determine available cargo space based at least in part on the inventory listing, specifications regarding cargo (e.g., dimensions, weight, fragility, temperature restrictions, etc.), and the specifications of the delivery resource 540 (e.g., cargo space dimensions, weight capacity, distance limits, etc.). Sensors can be used in part to confirm the inventory listing and the available cargo space.

By one approach, the databases 520 can include data received from one or more electronic user devices 550 (e.g., delivery resource data) and/or one or more delivery resources 540. In some embodiments, the geographic data 1122 can include one or more maps (e.g., two-dimensional, three-dimensional, or a combination thereof) of one or more particular areas of the earth (e.g., regions, cities, countries, etc.). The maps may include navigational information corresponding to roads, transport links, natural geographical information, topological information, satellite imagery, points of interest (e.g., prominent businesses or buildings, tourism sites, parks and recreational facilities, hotels and restaurants, airports and train stations, etc.), and/or similar information. The maps can be of any scale (e.g., feet, miles, kilometers, etc.) that facilitates one or more steps and/or processes of the instant teachings.

In some embodiments, one or more of the geographic data 522, mobile analytic data 524, and the delivery resource data 526 can each be configured as one or more external database communicatively coupled to the networks 530. Mobile analytic information (“MAI”) 524 can include mobile analytic information captured as defined above in reference to FIGS. 1-4. By one approach, the MAI 524 can include information corresponding to mobile analytics information for a plurality of mobile devices as well as information regarding the locations thereof. The mobile analytics data can include, inferentially or explicitly, temporal information as well. For example, the mobile analytics data may represent a particular window of time such as 10 minutes, one hour, or one day (to note but a few possibilities in these regards). By one approach, mobile analytic information 524 can include data generated/captured by mobile analytics server 404. In some embodiments, this mobile analytics information includes information regarding locations of user devices. In some embodiments, the mobile analytics data is anonymous (i.e., content typically lacks user names or other user monikers, telephone numbers, email addresses, or the like). In some embodiments, the mobile analytics data can be captured by a plurality of user-device interfaces (e.g., customer-device interfaces 405) positioned about one or more locations included in the geographic data 522 and configured to interact with mobile devices as they traverse such locations. As discussed above, the presence of mobile devices can be identified by their Media Access Control (MAC) addresses, which are identifiers assigned to network interfaces for communications at the data link layer of a network segment.

MAC addresses are also known as Ethernet hardware addresses, hardware addresses, or physical addresses. MAC addresses are formed according to the rules of one or three numbering name spaces managed by the Institute of Electrical and Electronic Engineers (i.e., MAC-48, EUI-48, and EUI-64). In one embodiment, user devices (e.g., customer devices 406 and similar devices) may include so-called smart phones, wearable computing devices, vehicular computing devices, and/or computing tablets having Wi-Fi and/or Bluetooth conductivity capabilities. When the user device is within a range of the user-device interface 405, these two elements may automatically communicate with one another during which communication the user device provides its MAC address to the user-device interface. The user-device interface then supplies that MAC address to the control circuit(s) 401, control circuit(s) 510, mobile analytic information 524, an external database(s) communicatively coupled to the network 530, or a combination of two or more thereof. In some embodiments, the mobile analytic information can include, for example, a mobile device Electronic Serial Number (ESN), a mobile device International Mobile Equipment Identity (IMEI) numbers, or (possibly random) numbers/identifiers assigned by wireless-communications service providers and/or parties providing the mobile analytics information.

In some embodiments, the delivery resource data 526 can include information corresponding to commercial distribution analytics information (“CDAI”). For example, the CDAI can include at least one of transportation information regarding a plurality of commercial delivery vehicles (e.g., delivery resources 540) each associated with a particular commercial entity, as well as delivery information regarding a plurality of commercial products each requiring delivery to a particular delivery destination and each associated with a particular commercial entity.

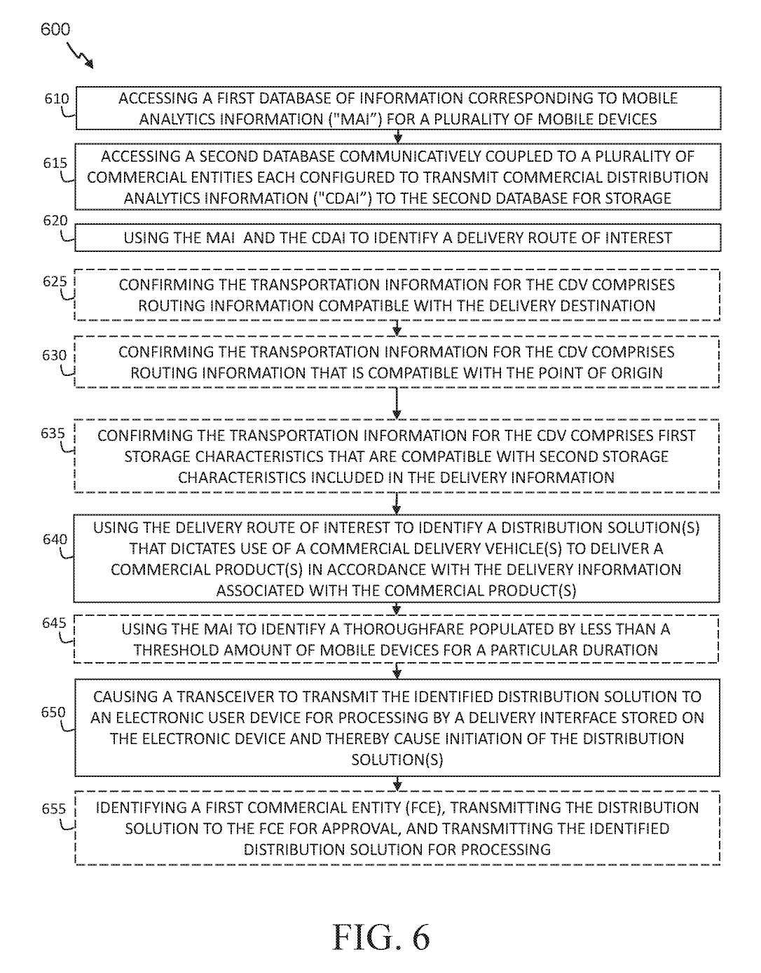

Referring now to FIG. 6. In particular, a process 600 can be at least partially implemented on or more control circuits 510, control circuits 401, electronic user devices 550, or a combination thereof. In some embodiments, the process 600 may be implemented when a plurality of commercial entities agree to share their delivery resources with a particular commercial entity to facilitate delivery of one or more commercial products of the particular commercial entity to a delivery destination. The process 600 can be implemented when the particular commercial entity does not have one or more of the delivery resources 540 available to facilitate the delivery. For example, commercial entities can opt in to the sharing agreement to afford themselves delivery capabilities, expand delivery capabilities to particular regions and/or municipalities, expand delivery capabilities to include particular dates/times, or a combination of two or more thereof. By one approach, the one or more control circuits 510 may be at least partially implemented on one or more electronic user devices, which can provide for a distribution of the processing tasks via the electronic user devices. In some embodiments, the one or more control circuits 510 are affiliated with and/or may be communicatively coupled to one or more commercial entities that can facilitate the conveyance of one or more commercial products to delivery destinations. One or more first databases of information corresponding to mobile analytics information (“MAI”) for a plurality of mobile devices can be assessed at block 610.

By one approach, the MAI can include information regarding the locations of the plurality of mobile devices. For example, the MAI can be stored in the mobile analytic information 524, a central database (s), or a database communicatively coupled to the networks 530. One or more second databases (e.g., delivery resource data 526, a central database(s), an external database(s) communicatively coupled to the networks 530) communicatively coupled to a plurality of commercial entities can be accessed at block 615, where each commercial entity (e.g., associated with one or more electronic user devices 550) can be configured to maintain and/or transmit commercial distribution analytics information (“CDAI”) to the second database for storage. By one approach, the CDAI can include transportation information (e.g., information regarding one or more commercial delivery vehicles (e.g., the delivery resources 540) each associated with a particular commercial entity), delivery information (e.g., information regarding one or more commercial products each to be delivered to a particular delivery destination and each associated with a particular commercial entity). In some embodiments, at least a portion of the CDAI can be received from one or more of the electronic user devices 550.

By one approach, for example, a map can include a plurality of waypoints (i.e., physical spaces corresponding to longitudinal and longitudinal coordinates) and edges, where each edge connects two waypoints. Each edge can have a value that represents a road distance between a particular waypoint pair. As such, edges may or may not represent unique values. Each waypoint can represent a point at which the course of the road can change (e.g., intersections, access points, junctions, on-ramps, off-ramps, similar locations where multiple roads intersect, allowing vehicular traffic to change from one road to another). A delivery route can correspond to a sequence of edges that are linked to each other at waypoints and form a path to traverse to reach a delivery destination or final point (e.g., Location B) from a point of origin or starting point (e.g., Location A). In many cases, more than one path links an origin to a destination.

At block 620, the MAI and the CDAI can be used to identify one or more delivery routes of interest (e.g., delivery routes of commercial resources 540 that can facilitate delivery of one or more commercial product according to the associated delivery request). For example, the CDAI (e.g., stored in the delivery resource data 526, the databases 520, an external database(s) communicatively coupled to the networks 530, or a combination of two or more thereof) can be assessed (e.g., using first-in-first-out, last-in-first-out, or similar queuing methodologies) to identify a delivery request to transport at least one commercial product (“the commercial product”) from Location A (“point of origin”) to Location B (“delivery destination”). In some embodiments, the delivery requests can also dictate a recipient of the commercial product (“Recipient”), a retrieval date/time, a delivery date/time, recipient identifying information, the dimensions of the commercial product, the climatic conditions at which to store the commercial product, similar delivery-related information, or a combination of two or more thereof.

In some embodiments, delivery requests are included in the CDAI by commercial entities to facilitate delivery of the commercial products using shared delivery resources. The CDAI can be assessed to identify one or more delivery resources 540 that have one or more compliant delivery routes and compliant cargo spaces 545 to facilitate delivery of one or more commercial products according to the associated delivery request. In some embodiments, compliant delivery routes can correspond to routes of the identified delivery resources 540 that can meet retrieval date/time requirements and/or delivery date/time requirements, have at least two waypoints and/or edges each positioned within a threshold distance of either Location A or Location B, or a combination thereof. For example, threshold distances can be user-defined (e.g., to allow users increased latitude for identifying compatible delivery resources 540), a distance that facilitates arrival at the point of origin and the delivery destination within a particular time period (e.g., as defined in seconds, minutes, hours, days, months, etc.) at a particular date, defined by the owner of the delivery resource 540, defined by cargo type (e.g., time sensitive, temperature sensitive, etc.), or a plurality of two or more thereof. For example, threshold distance may be different if there is limited time to get a current cargo to destination, than when there is more time available. By one approach, compliant cargo spaces can correspond to cargo spaces 545 of the CDAI having sufficient storage capacity (and at times towing capacity) to transport the commercial product(s) as well as climate conditions that are within a threshold climate range of the climate conditions dictated by the delivery request.

At block 625, the transportation information for the one or more CDVs can be confirmed to include routing information having at least one way point (and/or edge) that is within a threshold distance (as discussed above) of the particular delivery destination. At block 630, the transportation information for the one or more CDVs can be confirmed to include routing information having at least one way point positioned within a threshold distance (as discussed above) of a pickup location included in the delivery information (e.g., the CDAI) of the commercial product(s).

At block 635, the transportation information for the CDV can be confirmed to include one or more first storage characteristics that are at least within a threshold range of second storage characteristics included in the delivery information of the commercial product. For example, compliant cargo spaces can correspond to cargo spaces 545 of the CDAI having sufficient storage capacity (and at times towing capacity) to transport the commercial product(s) as well as climate conditions that are within a threshold climate range of the climate conditions dictated by the delivery request. By one approach, storage requirements dictated by the request (e.g., volume and/or climate requirements) can be compared to the storage and/or climate capabilities of the cargo spaces 545 of each identified delivery resource 540. For example, threshold climate ranges can be a user-defined range, a range that known in the art to reduce or inhibit bacterial growth, about 37-43° F. (i.e., at/near refrigeration), about 3° F. or less (i.e., near/below freezing), a climate range that facilitates storage of perishable commercial items (e.g., meat, poultry, fish, dairy products, cooked food, similar perishable items, etc.)

At block 640, the delivery route(s) of interest and the CDAI can be used to identify a distribution solution that dictates use of a CDV of the plurality of CDVs to deliver the commercial product(s) of the plurality of commercial products in accordance with the delivery information associated with the commercial product (e.g., the information included in the request). As used herein, a “distribution solution” can correspond to information that prescribes the use of a delivery resource(s) 540 having a delivery route(s) and a cargo space(s) 545 that facilitates the transportation of a commercial product(s) from a point of origin(s) to a delivery destination(s) as dictated in a delivery request(s). Additionally or alternatively, delivery destinations can correspond to temporary storage locations for commercial products from which such products can be retrieved and transported to additional delivery destinations and/or final points. For example, as discussed above, a delivery route can correspond to a sequence of edges that are linked to each other at waypoints and form a path to traverse to reach a delivery destination or final point (e.g., Location B) from a point of origin or starting point (e.g., Location A). In many cases, more than one compliant delivery route may link the point of origin to the delivery destination. By one approach, transportation times of a plurality of compliant delivery routes can be compared to the delivery date/time(s) dictated by the request to determine the particular delivery resource 540 having a compliant delivery route with the shortest transportation time (i.e., the quickest delivery capabilities).

At block 645, information included in the MAI of the mobile analytic information 524 can be used to identify one or more routes and/or thoroughfares populated by less than a threshold amount of mobile devices for a particular duration. For example, to identify a distribution solution, the MAI can be used to identify one or more thoroughfares (e.g., edges of waypoint pairs) populated by less than a threshold amount of mobile devices for a particular duration (e.g., a duration corresponding to pickup date/time and the delivery date/time). For example, the MAI can be used to identify one or more waypoint pairs of the map having an edge populated by at least a threshold amount of mobile devices, and thereby identify those edges having less than a threshold amount of mobile devices (i.e., low traffic volume). By one approach, identifying edges populated by at least the threshold amount of mobile devices can allow such edges to be disregarded when identifying the distribution solution, which can decrease the computational load required for such identifications. The threshold amount of mobile devices can be determined using a plurality of techniques.

By one approach, traffic flow can be described using the traffic stream variables of speed, flow, and concentration. Flow conditions can refer to the mobile device density per mile per lane for a particular edge and can be considered “free” when the density is less than 12 mobile devices are detected by user-device interface 552; “stable” at 12-30 mobile devices; “maximized” when the density exceeds 30 mobile devices; “broken-down” when the density exceeds 67 mobile devices; and “jammed” when the density exceeds 185-250 mobile devices. In some embodiments, the threshold amount can be set to a user's preferred flow condition; to avoid maximized, broken-down, and/or jammed flow conditions; to ensure a minimum speed; achieve similar traffic stream characteristic; or a combination of two or more thereof.

In some embodiments, for each identified delivery route, the fastest route (i.e., route requiring the least amount of time) between the particular delivery resource's current or future location, Location A, and Location B can be determined using a plurality of methods (e.g., Dijkstra's algorithm, Bellman Ford's algorithm, Floyd-Marshall's algorithm, similar methods, or a combination of two or more thereof), which are commonly known in the art and need not be repeated herein. By one approach, only edges that correspond to the preferred flow condition(s) are analyzed, which can reduce the number of edges requiring analysis (decrease analysis time). As discussed above, a map can be represented as a multitude of interconnected waypoints each connected to at least one other waypoint by an edge, where all series of interconnected waypoints (or a portion thereof) between the delivery resource 540 and Location A (series 1) as well as those between Location A and Location B (series 2) are analyzed to identify the distribution solution (e.g., the particular waypoint series 1 and 2 each corresponding to the least amount of time of their particular series).

At block 650, a transceiver (e.g., communicatively coupled to the control circuits 510) can be caused to transmit the identified distribution solution to one or more electronic user devices (e.g., electronic user devices 550) for processing by a delivery interface (e.g., delivery interface 552) stored on the electronic device and thereby cause initiation of the distribution solution. For example, at block 655, the first commercial entity of the plurality of commercial entities that is associated with the commercial product can be identified, the distribution solution can be transmitted to the identified first commercial entity for approval (e.g., of one or more distribution solution details discussed above), the identified distribution solution can be transmitted to the one or more electronic devices for processing by the delivery interface when the approval is received. Additionally or alternatively, the distribution solution can be transmitted to the entity associated with the delivery vehicle for approval and/or rejection.

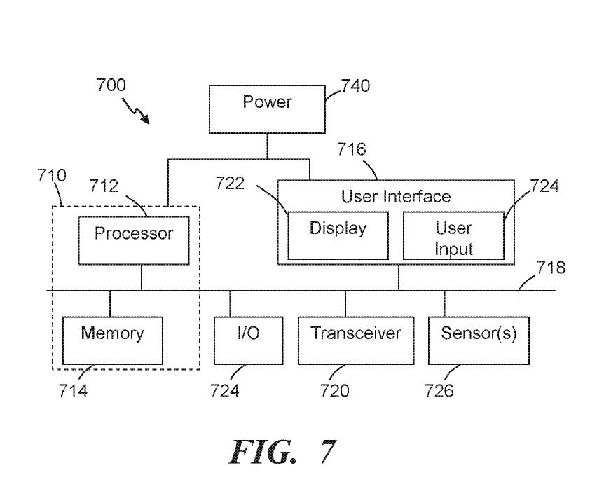

Further, the circuits, circuitry, systems, devices, processes, methods, techniques, functionality, services, servers, sources and the like described herein may be utilized, implemented and/or run on many different types of devices and/or systems. FIG. 7 illustrates an exemplary system 700 that may be used for implementing any of the components, circuits, circuitry, systems, functionality, apparatuses, processes, or devices of the delivery resources 540, the electronic user devices 550, the control circuits 510, the control circuit 401 and/or other above or below mentioned systems or devices, or parts of such circuits, circuitry, functionality, systems, apparatuses, processes, or devices. For example, the system 700 may be used to implement some or all of the electronic user devices 550, the delivery resources 540, the control circuits 510, the control circuits 401, one or more remote central control systems, and/or other such components, circuitry, functionality and/or devices. However, the use of the system 700 or any portion thereof is certainly not required.

By way of example, the system 700 may comprise a control circuit or processor module 712, memory 714, and one or more communication links, paths, buses or the like 718. Some embodiments may include one or more user interfaces 716, and/or one or more internal and/or external power sources or supplies 740. The control circuit 712 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 712 can be part of control circuitry and/or a control system 710, which may be implemented through one or more processors with access to one or more memory 714 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 700 may be used to implement one or more of the above or below, or parts of, components, circuits, systems, processes and the like.

The user interface 716 can allow a user to interact with the system 700 and receive information through the system. In some instances, the user interface 716 includes a display 722 and/or one or more user inputs 724, such as buttons, touch screen, track ball, keyboard, mouse, etc., which can be part of or wired or wirelessly coupled with the system 700. Typically, the system 700 further includes one or more communication interfaces, ports, transceivers 720 and the like allowing the system 700 to communicate over a communication bus, a distributed computer and/or communication network 530 (e.g., a local area network (LAN), the Internet, wide area network (WAN), etc.), communication link 718, other networks or communication channels with other devices and/or other such communications or combination of two or more of such communication methods. Further the transceiver 720 can be configured for wired, wireless, optical, fiber optical cable, satellite, or other such communication configurations or combinations of two or more of such communications. Some embodiments include one or more input/output (I/O) ports 734 that allow one or more devices to couple with the system 700. The I/O ports can be substantially any relevant port or combinations of ports, such as but not limited to USB, Ethernet, or other such ports. The I/O interface 734 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 726 to provide information to the system and/or sensor information that is communicated to another component, such as the central control system, control circuits 510, control circuits 401, electronic user devices 550 etc. The sensors can include substantially any relevant sensor, such as distance measurement sensors (e.g., optical units, sound/ultrasound units, etc.), cameras, motion sensors, inertial sensors, climate sensors (e.g., temperature, humidity, pressure, etc.), accelerometers, impact sensors, pressure sensors, geopositional sensors, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 700 comprises an example of a control and/or processor-based system with the control circuit 712. Again, the control circuit 712 can be implemented through one or more processors, controllers, central processing units, logic, software and the like. Further, in some implementations the control circuit 712 may provide multiprocessor functionality.

The memory 714, which can be accessed by the control circuit 712, typically includes one or more processor readable and/or computer readable media accessed by at least the control circuit 712, and can include volatile and/or nonvolatile media, such as RAM, ROM, EEPROM, flash memory and/or other memory technology. Further, the memory 714 is shown as internal to the control system 710; however, the memory 714 can be internal, external or a combination of internal and external memory. Similarly, some or all of the memory 714 can be internal, external or a combination of internal and external memory of the control circuit 712. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 530. The memory 714 can store code, software, executables, scripts, data, content, lists, programming, programs, log or history data, commercial item information, purchase opportunities, partiality vectors, and the like. While FIG. 7 illustrates the various components being coupled together via a bus, it is understood that the various components may actually be coupled to the control circuit and/or one or more other components directly.

In some embodiments, systems are provided to enable sharing of commercial delivery vehicles across multiple commercial entities to facilitate the delivery of commercial products, and may comprise: one or more control circuits communicatively coupled to a transceiver, one or more electronic user devices (e.g., each comprising a delivery interface stored thereon), one or more first databases of information, and one or more second database of information. By one approach, the first databases of information can include information corresponding to mobile analytics information (“MAI”) for a plurality of mobile devices as well as information regarding the locations of the plurality of mobile devices.

By one approach, the second database of information can be communicatively coupled to a plurality of commercial entities (e.g., nonaffiliated commercial entities) each configured to transmit commercial distribution analytics information (“CDAI”) to the second database for storage. For example, the CDAI can include at least one of: transportation information regarding a plurality of commercial delivery vehicles (“CDV”) each associated with a particular first commercial entity of the plurality of commercial entities, and delivery information regarding a plurality of commercial products each requiring delivery to a particular delivery destination and each associated with a particular second commercial entity of the plurality of commercial entities.

The one or more control circuits can be configured to use the CDAI to identify one or more delivery routes of interest. The one or more control circuits can be configured to use the delivery route of interest, the MAI, and the CDAI to identify a distribution solution(s) that dictates use of one or more CDVs of the plurality of CDVs to deliver one or more commercial products of the plurality of commercial products in accordance with the delivery information associated with the one or more commercial products. The one or more control circuits can be configured to cause the transceiver to transmit the distribution solution(s) to the electronic user device(s) for processing by the delivery interface(s) and thereby cause initiation of the distribution solution(s).

In some embodiments, methods are provided to enable the sharing of delivery vehicles across multiple commercial entities to facilitate the delivery of commercial products. Some of these methods access one or more first databases of information corresponding to mobile analytics information (“MAI”) for a plurality of mobile devices. By one approach, the MAI can include information regarding the locations of the plurality of mobile devices. accessing, via the control circuit, One or more second databases communicatively coupled to a plurality of commercial entities can be accessed, where each commercial entity can be configured to transmit commercial distribution analytics information (“CDAI”) to the one or more second databases for storage. By one approach, the CDAI can include at least one of: transportation information regarding a plurality of commercial delivery vehicles (“CDV”) each associated with a particular first commercial entity of the plurality of commercial entities, and delivery information regarding a plurality of commercial products each to be delivered to a particular delivery destination and each associated with a particular second commercial entity of the plurality of commercial entities.

The CDAI can be used to identify at least one delivery route of interest. The delivery route of interest, the MAI, and the CDAI can be used to identify a distribution solution that dictates use of one or more CDVs of the plurality of CDVs to deliver a commercial product(s) of the plurality of commercial products in accordance with the delivery information associated with the commercial product(s). The identified distribution solution(s) can be transmitted to an electronic user device via a transceiver(s) for processing by a delivery interface(s) stored on the electronic device(s) and thereby cause initiation of the distribution solution(s).

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system to enable sharing of commercial delivery vehicles across multiple commercial entities to facilitate the delivery of commercial products comprising:
an electronic user device comprising a delivery interface stored thereon;
a first database of information corresponding to mobile analytics information (“MAI”) for a plurality of mobile devices and comprising information regarding locations of the plurality of mobile devices;
a second database of information communicatively coupled to a plurality of commercial entities each configured to transmit commercial distribution analytics information (“CDAI”) to the second database for storage, the CDAI comprising at least one of: transportation information regarding a plurality of commercial delivery vehicles (“CDV”) each associated with a particular first commercial entity of the plurality of commercial entities, and delivery information regarding a plurality of commercial products each requiring delivery to a particular delivery destination and each associated with a particular second commercial entity of the plurality of commercial entities; and
a control circuit communicatively coupled to the electronic user device, the first database, the second database, and a transceiver, the control circuit configured to:
use the CDAI to identify a delivery route of interest;
use the delivery route of interest, the MAI, and the CDAI to identify a distribution solution that dictates use of a CDV of the plurality of CDVs to deliver a commercial product of the plurality of commercial products in accordance with the delivery information associated with the commercial product; and
cause the transceiver to transmit the distribution solution to the electronic user device for processing by the delivery interface and thereby cause initiation of the distribution solution.

2. The system of claim 1, wherein in identifying the delivery route of interest the control circuit is configured to confirm that the transportation information for the CDV comprises routing information that includes at least one way point that is within a threshold distance of the particular delivery destination.

3. The system of claim 1, wherein in identifying the delivery route of interest the control circuit is configured to confirm that the transportation information for the CDV comprises routing information that includes at least one way point that is within a threshold distance of a pickup location included in the delivery information of the commercial product.

4. The system of claim 1, wherein in identifying the delivery route of interest the control circuit is configured to confirm that the transportation information for the CDV includes first storage characteristics that are at least within a threshold range of second storage characteristics included in the delivery information of the commercial product.

5. The system of claim 1, wherein in identifying the distribution solution the control circuit is configured to use the MAI to identify a thoroughfare populated by less than a threshold amount of mobile devices for a particular duration.

6. The system of claim 1, wherein the electronic device is incorporated in one of an autonomous vehicle and a semi-autonomous vehicle.

7. The system of claim 1, wherein in causing the transceiver to transmit the identified distribution solution the control circuit is configured to:
identify a first commercial entity of the plurality of commercial entities associated with the commercial product;
cause the transceiver to transmit the distribution solution to the identified first commercial entity for approval; and
cause the transceiver to transmit the identified distribution solution to the electronic device for processing by the delivery interface when the approval is received.

8. A method to enable the sharing of delivery vehicles across multiple commercial entities to facilitate the delivery of commercial products comprising:
accessing, via a control circuit, a first database of information corresponding to mobile analytics information (“MAI”) for a plurality of mobile devices, the MAI comprising information regarding locations of the plurality of mobile devices;
accessing, via the control circuit, a second database communicatively coupled to a plurality of commercial entities each configured to transmit commercial distribution analytics information (“CDAI”) to the second database for storage, the CDAI comprising at least one of: transportation information regarding a plurality of commercial delivery vehicles (“CDV”) each associated with a particular first commercial entity of the plurality of commercial entities, and delivery information regarding a plurality of commercial products each to be delivered to a particular delivery destination and each associated with a particular second commercial entity of the plurality of commercial entities;
using, via the control circuit, the CDAI to identify a delivery route of interest;
using, via the control circuit, the delivery route of interest, the MAI, and the CDAI to identify a distribution solution that dictates use of a CDV of the plurality of CDVs to deliver a commercial product of the plurality of commercial products in accordance with the delivery information associated with the commercial product; and
causing, via the control circuit, a transceiver to transmit the identified distribution solution to an electronic user device for processing by a delivery interface stored on the electronic device and thereby cause initiation of the distribution solution.

9. The method of claim 8, wherein identifying the delivery route of interest comprises confirming, via the control circuit, that the transportation information for the CDV comprises routing information that comprises at least one waypoint that is within a threshold distance of the particular delivery destination.

10. The method of claim 8, wherein identifying the delivery route of interest comprises confirming, via the control circuit, that the transportation information for the CDV comprises routing information that comprises at least one waypoint that is within a threshold distance of a pickup location included in the delivery information of the commercial product.

11. The method of claim 8, wherein identifying the delivery route of interest comprises confirming, via the control circuit, that the transportation information for the CDV comprises first storage characteristics that are at least within a threshold range of second storage characteristics included in the delivery information of the commercial product.

12. The method of claim 8, wherein identifying the distribution solution comprises using, via the control circuit, the MAI to identify a thoroughfare populated by less than a threshold amount of mobile devices for a particular duration.

13. The method of claim 8, wherein the electronic device is incorporated in one of an autonomous vehicle and a semi-autonomous vehicle.

14. The method of claim 8, wherein causing the transceiver to transmit the identified distribution solution comprises:
identifying, via the control circuit, a first commercial entity of the plurality of commercial entities associated with the commercial product;
causing, via the control circuit, the transceiver to transmit the distribution solution to the identified first commercial entity for approval; and
causing, via the control circuit, the transceiver to transmit the identified distribution solution to the electronic device for processing by the delivery interface when the approval is received.
